(19) United States
(12) Patent Application Publication
(10) Pub. No.: US 2005/0153689 A1
(43) Pub. Date: Jul. 14, 2005

(54) Portable storage device and method for controlling cellular phone thereof

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/753,429

(22) Filed: Jan. 9, 2004

(51) Int. Cl. H04Q 7/00

(52) U.S. Cl. 455/420

(57) ABSTRACT

A portable storage device and a method for controlling a cellular phone thereof. The portable storage device has a Bluetooth module capable of connecting with a remote Bluetooth cellular phone in a wireless manner. The device includes: a digital signal processing (DSP) unit for processing digital data; a voice signal transmission and encoding/decoding unit connecting with the DSP unit, the earphone and the microphone for voice encoding/decoding and digital/analog data converting; and a Bluetooth module connecting with the voice signal transmission and encoding/decoding unit for receiving a message signal and transmitting a replay modulation signal.

### FIELD OF THE INVENTION

The present invention is directed to a portable storage device and a method for controlling a cellular phone thereof, and more particularly, to a portable storage device that is capable of controlling a cellular phone and its method for controlling the cellular phone.

### BACKGROUND OF THE INVENTION

As for conventional MP3 music files, which are compressed by employing MPEGIII standard, due to their sizes are small, they can be stored in a memory abundantly. Further, since the tone qualities of the decompressed MP3 music files are not bad when played, the MP3 music files are popularly used day by day.

As the progress of the memory techniques, many electronic products are made smaller and smaller, but they can still accommodate the data with hundreds of megabytes. If the extended memory card is used, the storage capacity can be further increased. Moreover, due to the versatile processing chips are applied, the functions of the electronic products are increased unceasingly. For instant, the popularly used portable disk, which can store a great quantity of digital data, employs a flash memory and using a Universal Serial Bus (USB) interface to connect with a computer.

If a portable storage device is equipped with a MP3 processing chip, the pop songs stored in a flash memory of the portable storage device in the manner of MP3 music files can be played via the MP3 processing chip and the portable storage device can become a MP3 player. Further, the portable storage device can also connect with an extended memory card to increase its storage capacity. Hence, the portable storage device can serve as a portable disk and a MP3 player.

On the other hand, Bluetooth technique is a low-cost, low-power and short-distant wireless communication technique, which can be extensively applied to any kind of personal wireless communication equipment. Since Bluetooth technique is popularized gradually, the Bluetooth earphones have already appeared in the market and are usually applied to cellular phones to serve as hand-free handsets. These Bluetooth earphones only have this single function and can't be used for other purposes.

Consequently, the inventor combines the portable storage device described above with a Bluetooth module for replacing the conventional wired line in digital transmission. Thereby, the portable storage device of the present invention can be used to transmit/receive voice or data message to/from a Bluetooth cellular phone. Hence, a user can recognize the identity of the other side via the incoming message shown on a display unit of the portable storage device complied with the present invention. Further, the user can also use an input unit of the portable storage device to make the Bluetooth cellular phone dial and store or edit incoming phone numbers.

### SUMMARY OF THE INVENTION

An objective of the present invention is to provide a portable storage device with a Bluetooth module, which can connect with a remote Bluetooth cellular phone in a wireless manner so as to transmit/receive voice or data message to/from the Bluetooth cellular phone. Further, the portable storage device has a display unit used for displaying incoming messages and an input unit for controlling the storing or editing of the incoming messages. The input unit can also be used to input a phone number to make the Bluetooth cellular phone dial.

For reaching the objective above, the present invention provides a portable storage device capable of controlling a cellular phone. It includes: a digital signal processing (DSP) unit for processing digital data; a voice signal transmission and encoding/decoding unit connecting with the DSP unit for voice encoding/decoding and digital/analog data converting; a Bluetooth module connecting with the voice signal transmission and encoding/decoding unit for receiving a message signal and transmitting a replay modulation signal; and an input unit connecting with the DSP unit for inputting a control signal.

Numerous additional features, benefits and details of the present invention are described in the detailed description, which follows.

### BRIEF DESCRIPTION OF THE DRAWINGS

FIG. 1 is a schematic diagram of a portable storage device communicated with a Bluetooth cellular phone in accordance with the present invention.

FIG. 2 is a block diagram of the portable storage device in accordance with the present invention.

FIG. 3 is a flowchart of a cellular phone controlling method in accordance with the present invention.

FIG. 4 is a flowchart of a method for storing incoming phone numbers in accordance with the present invention.

### DETAILED DESCRIPTION

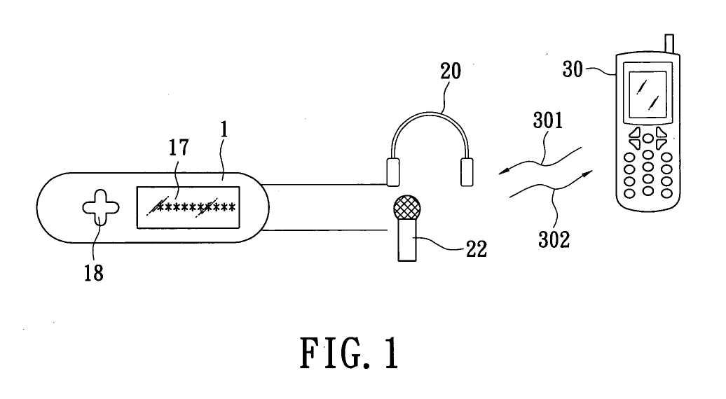

Please refer to FIG. 1, which is a schematic diagram of a portable storage device communicated with a Bluetooth cellular phone in accordance with the present invention. As shown in the figure, the portable storage device 1 of the present invention connects with an earphone 20 for a user to hear the MP3 music files played by the portable storage device 1. The portable storage device 1 can also receive a message signal 301 from a remote Bluetooth cellular phone 30 and send a reply modulation signal 302 to the Bluetooth cellular phone 30. After received the message signal 301, the portable storage device 1 will display an incoming phone number on a display unit 17 according to the message signal 301 so that the user can recognize the identity of the other side and decide if he needs to answer the phone. When received the incoming phone number, the user can manipulate an input unit 18 to store or edit the phone number. The user can also manipulate the input unit 18 to input a phone number, send it to the Bluetooth cellular phone 30 and control the Bluetooth cellular phone 30 to dial, and then the user can use a microphone 22 and the earphone 20 to communicate with others.

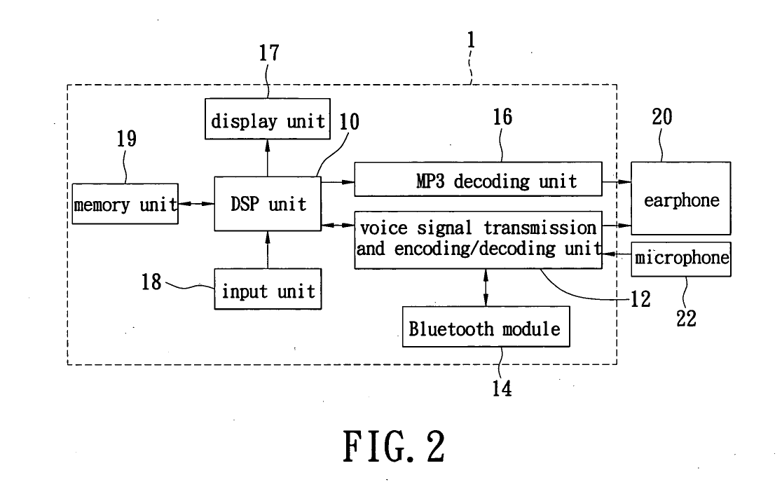

Please refer to FIG. 2, which is a block diagram of the portable storage device complied with the present invention. The portable storage device 1 connecting with an earphone 20 and a microphone 22 comprises: a digital signal processing (DSP) unit 10, a voice signal transmission and encoding/decoding unit 12, a Bluetooth module 14, a MP3 decoding unit 16, a display unit 17, an input unit 18 and a memory unit 19. The DSP unit 10 connects with the MP3 decoding unit 16, display unit 17, input unit 18 and the memory unit 19. A user can input a control signal via the input unit 18 to control the DSP unit 10 to process the MP3 digital file stored in the memory unit 19 and send the MP3 digital file to the MP3 decoding unit 16 for decoding. After decoded, the MP3 digital file becomes a voice signal and is outputted to the earphone 20 so that the user can hear the voice content of the MP3 digital file via the earphone 20. Furthermore, the display unit 17 can also display the related message of the MP3 digital file so as to make the user realize the content of the displayed MP3 digital file.

Please refer to FIGS. 1 and 2 again. The voice signal transmission and encoding/decoding unit 12 connects with the DSP unit 10, Bluetooth module 14, earphone 20 and microphone 22. The voice signal transmission and encoding/decoding unit 12 is used for encoding/decoding voice and converting digital/analog messages. It can decode the message signal 301 received by the Bluetooth module 14 and display a incoming phone number via the display unit 17 after employing the DSP unit 10 to process the message signal 301. It can also encode the message processed by the DSP unit 10 and send the reply modulation signal 302 to the Bluetooth cellular phone 30 via the Bluetooth module 14.

When getting a phone call, the Bluetooth module 14 will receive the message signal 301 and then pass it to the voice signal transmission and encoding/decoding unit 12 for decoding. Subsequently, after processed by the DSP unit 10, the message signal 301, which is an incoming phone number, will be shown on the display unit 17. Accordingly, a user can recognize the identity of the other side and decide if it is necessary to answer the phone.

At this time, if the user chooses to answer the phone, the incoming voice signal can be heard by the user clearly via the earphone 20 after processed by the DSP unit 10. Further, if the user is listening to a voice message of a MP3 music file via the earphone 20 at this time, the DSP unit 10 will interrupt the playing of the MP3 file in advance and then the user can hear the telephone voice message via the earphone 20. When the phone is hung up, the DSP 10 will recover the playing of the MP3 file.

Meanwhile, when the user speaks, the voice message will be sent via the microphone 22 to the voice signal transmission and encoding/decoding unit 12. After processed by the voice signal transmission and encoding/decoding unit 12, the voice message will be passed to the Bluetooth module 14. Then, the Bluetooth module 14 will send a corresponding reply modulation signal 302 to the remote Bluetooth cellular phone 14 (see FIG. 1). By this way, the full-duplex voice communication can be obtained.

Please refer to FIGS. 1 and 2 again. The portable storage device 1 of the present invention can use the input unit 18 to input a phone number or search the phone numbers pre-stored in the memory unit 19. The user can manipulate the input unit 18 to control the DSP unit 10 to process the inputted or chosen phone number. Subsequently, the voice signal transmission and encoding/decoding unit 12 will process the phone number and then the Bluetooth module 14 will sent it to the Bluetooth cellular phone 30 to make a phone call.

Thereby, the portable storage device 1 of the present invention can perform full-duplex voice communication via the Bluetooth module 14. Meantime, the phone number of the other side can also be shown on the display unit 17. Hence the user can recognize the identity of the other side and decide if he needs to answer the phone call. Further, the user can edit the incoming phone numbers via the display unit 17 and then store they into the memory unit 19 as pre-stored ones. The user can also manipulate the input unit 18 to input a phone number or choose one of the pre-stored phone numbers and then pass the inputted or chosen phone number and a control signal to the Bluetooth cellular phone 30 to make a phone call.

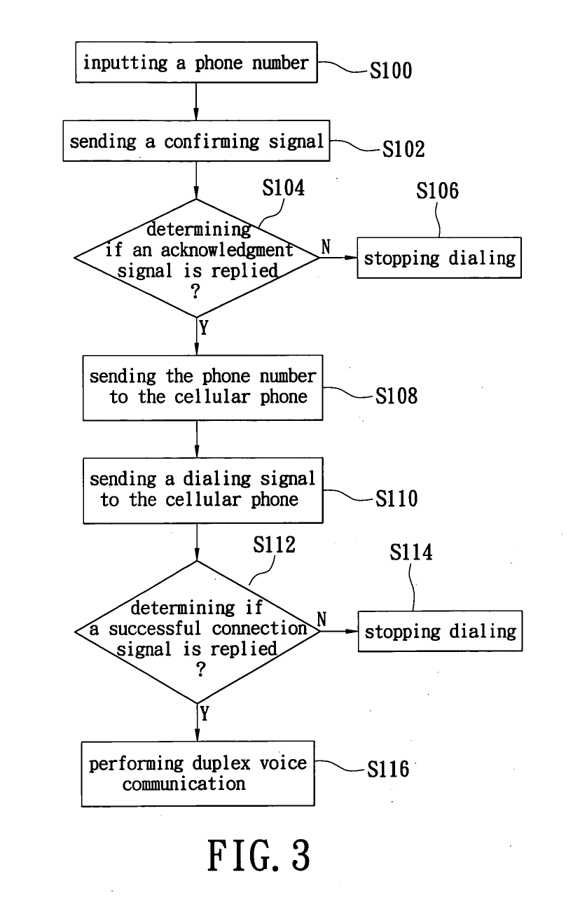

Next, a cellular phone controlling method of the portable storage device 1 complied with the present invention is described as following. Please refer to FIG. 3, which is a flowchart of the cellular phone controlling method of the portable storage device in accordance with the present invention. The method includes: inputting a phone number into the portable storage device of the present invention (S100); subsequently, sending a confirming signal to the Bluetooth cellular phone (S102); then, determining if the Bluetooth cellular phone replied an acknowledgment signal (S104); if positive, send the phone number to the Bluetooth cellular phone (S108); sending a dialing signal to the Bluetooth cellular phone (S110); then, determining if the Bluetooth cellular phone replied a successful connection signal (S112); finally, performing full-duplex voice communication (S116). Therein, after the step of determining if the Bluetooth cellular phone replied the acknowledgment signal (S104), if the determination is negative, stop dialing (S106); after the step of determining if the Bluetooth cellular phone replied a successful connection signal (S112), if the determination is negative, also stop dialing (S114).

Please refer to FIGS. 1 and 3, in the steps of the cellular phone controlling method of the portable storage device, a user can use the input unit 18 to input the phone number or choose one of the phone numbers pre-stored in the memory unit 19 and then send the confirming signal to the Bluetooth cellular phone 30 to determine if the Bluetooth cellular phone 30 is alive. If the Bluetooth cellular phone 30 isn't alive, the portable storage device 1 will stop dialing. Otherwise, the Bluetooth cellular phone 30 will send the acknowledgment signal to the portable storage device 1 and then the portable storage device 1 will send the inputted or chosen phone number to the Bluetooth cellular phone 30. Subsequently, the portable storage device 1 will send the dialing signal to the Bluetooth cellular phone 30 to make it dial. Then, the portable storage device 1 will determine if the Bluetooth cellular phone 30 replied the successful connection signal. If positive, perform full-duplex voice communication; otherwise, the portable storage device 1 will stop the action of dialing.

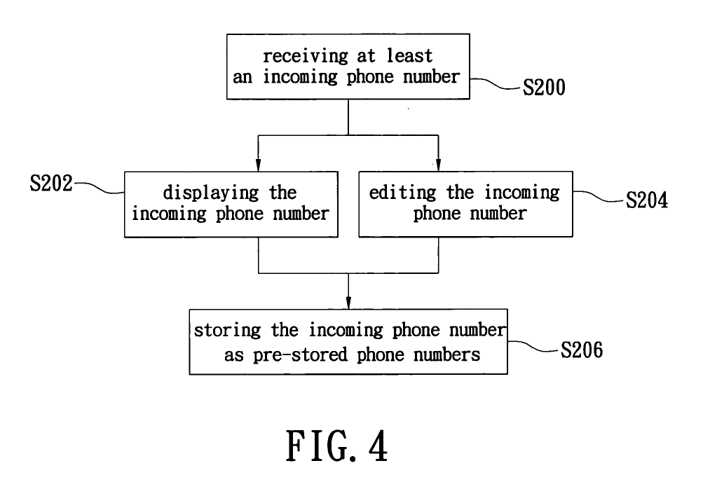

Please refer to FIG. 4, which is a flowchart of a method of the portable storage device for storing incoming phone numbers in accordance with the present invention. The method includes: receiving at least an incoming phone number (S200); next, editing the incoming phone number (S204); finally, storing the incoming phone number as the pre-stored phone numbers (S206). Therein, after the step of receiving at least an incoming phone number (S200), the method further has a step of displaying the incoming phone number (S202).

Please refer to FIGS. 1 and 4. In the steps of the method for storing incoming phone numbers, the portable storage device 1 can receive at least an incoming phone number via the Bluetooth cellular phone 30 and then display the incoming phone number on the display unit 17. At this time, a user can manipulate the input unit 18 to control the DSP unit 10 to process and edit the phone number and then store it as a pre-stored phone number.

As mentioned above, the portable storage device and its method for controlling a cellular phone of the present invention can be used to perform wireless connection with the remote Bluetooth cellular phone via the Bluetooth module. Hence, the present invention can be used to transmit/receive voice or data message to/from the Bluetooth cellular phone.

Furthermore, the present invention can display the incoming message via the display unit of the portable storage device. A user can manipulate the input unit of the portable storage device to store or edit the incoming message or input a phone number to make the Bluetooth cellular phone dial.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for controlling a cellular phone, which is applied to a portable storage device for remotely controlling the cellular phone to dial, the method comprising:
inputting a phone number;
transmitting the phone number to the cellular phone;
sending a dialing signal to the cellular phone to make the cellular phone dial the phone number; and
performing duplex voice transmission.

2. The method as claimed in claim 1 further comprising following steps after the step of inputting the phone number:
sending a confirming signal to the cellular phone;
determining if the cellular phone replied an acknowledgment signal; and
stopping a dialing action if a negative determination is made.

3. The method as claimed in claim 1 further comprising following steps after the step of sending the dialing signal to the cellular phone:
determining if the cellular phone sent back a successful connection signal; and
stopping a dialing action if the successful connection signal is not sent.

4. The method as claimed in claim 1, wherein the step of inputting the phone number is performed by choosing one of pre-stored phone numbers.

5. The method as claimed in claim 4, wherein the pre-stored phone numbers are incoming phone numbers sent from the cellular phone previously, steps for storing the incoming phone numbers comprising:
receiving at least one of the incoming phone number; and
storing the incoming phone numbers as the pre-stored phone numbers.

6. The method as claimed in claim 5 further comprising a step of displaying the incoming phone numbers after the step of receiving at least one of the incoming phone numbers.

7. The method as claimed in claim 5 further comprising a step of editing the incoming phone numbers after the step of receiving at least one of the incoming phone numbers.

8. The method as claimed in claim 1, wherein the cellular phone is a Bluetooth cellular phone.

9. A portable storage device, which connects with an earphone and a microphone, the device comprising:
a digital signal processing (DSP) unit for processing digital data;
a voice signal transmission and encoding/decoding unit connecting with the DSP unit, the earphone and the microphone for voice encoding/decoding and digital/analog data converting; and
a Bluetooth module connecting with the voice signal transmission and encoding/decoding unit for receiving a message signal and transmitting a replay modulation signal.

10. The device as claimed in claim 9 further comprising a MP3 decoding unit connecting with the DSP unit and the earphone for decoding a MP3 digital file to recover a voice signal.

11. The device as claimed in claim 9 further comprising an input unit connecting with the DSP unit for inputting a control signal.

12. The device as claimed in claim 9 further comprising a display unit connecting with the DSP unit for displaying a digital message sent from the DSP unit.

13. The device as claimed in claim 9 further comprising a memory unit connecting with the DSP unit for storing the digital data.
